(19) United States
(12) Patent Application Publication
(10) Pub. No.: US 2006/0116179 A1
(43) Pub. Date: Jun. 1, 2006

(54) System and method for optimizing power consumption in a wireless device

(76) Inventor: Sarosh Vensuna, Los Altos, CA (US)

Correspondence Address: FAY KAPLUN & MARCIN, LLP, 15O BROADWAY, SUITE 702, NEW YORK, NY, 10038, US

(21) Appl. No.: 11/001,540

(22) Filed: Nov. 30, 2004

(51) Int. Cl. H04M 1/00

(52) U.S. Cl. 455/574; 455/572

(57) ABSTRACT

Described is a system and a method for optimizing power consumption in a wireless device. The system may include a first computing device which includes a first wireless transducer and a second computing device which includes a second wireless transducer and a power adjusting arrangement. The second transducer wirelessly transmits to the first device first data at a first transmitting power and second data at a second transmitting power. The power adjusting arrangement determines the second transmitting power as a function of the first transmitting power and receipt data; the receipt data corresponding to one of (i) an acknowledgment from the first device of reception of the first data and a signal strength of the received first data and (ii) a lack of acknowledgment from the first device of reception of the first data.

### FIELD OF INVENTION

The present invention relates generally to a wireless network and a wireless device. In particular, the present invention relates to a system and method for optimizing power consumption in a wireless device.

### BACKGROUND INFORMATION

A wireless device, such as a wireless personal data assistant, may transmit and receive data via a wireless network (e.g., an 802.11 wireless LAN network). The wireless network generally includes at least one access point to receive and transmit the data.

The effective transmitting radius of an access point in a wireless network depends in part on a transmitting power level of the access point. The transmitting power level may generally be controlled at the particular access point. For example, the access point with a smaller radius would generally maintain a lower transmitting power level than the access point with the larger radius. Therefore, the power level is kept high enough to effectively communicate with the wireless devices within a desired radius, but low enough not to interfere with communications with neighboring access points and/or wireless networks. However, wireless devices typically have a single transmitting power level (e.g., a maximized power level) to allow for compatibility with any access point.

### SUMMARY OF INVENTION

The present invention relates to a system and a method for optimizing power consumption in a wireless device. Described is a system and a method for optimizing power consumption in a wireless device. The system may include a first computing device which includes a first wireless transducer and a second computing device which includes a second wireless transducer and a power adjusting arrangement. The second transducer wirelessly transmits to the first device first data at a first transmitting power and second data at a second transmitting power. The power adjusting arrangement determines the second transmitting power as a function of the first transmitting power and receipt data; the receipt data corresponding to one of (i) an acknowledgment from the first device of reception of the first data and a signal strength of the received first data and (ii) a lack of acknowledgment from the first device of reception of the first data.

### BRIEF DESCRIPTION OF THE DRAWINGS

FIG. 1 shows an exemplary system according to the present invention.

FIG. 2 shows an exemplary method according to the present invention.

### DETAILED DESCRIPTION

The present invention relates to a system and method for optimizing power consumption in a wireless device. In particular, the present invention allows for a wireless device to monitor and adjust its transmitting power level to use a minimum required power at a given time.

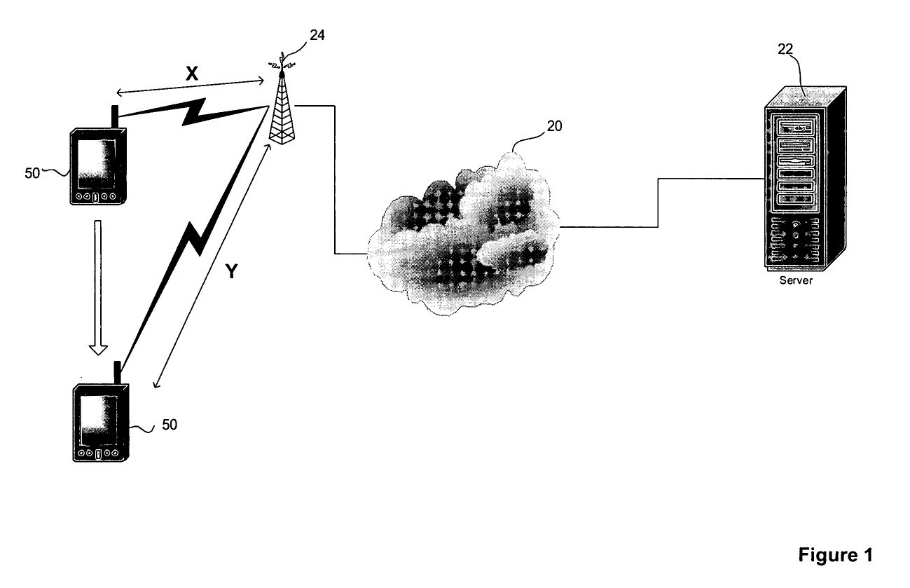

FIG. 1 shows an exemplary embodiment of a system 10 according to the present invention. The system 10 includes a communications network 20 which may include, for example, a local area network (“LAN”), an Intranet, a wireless LAN (“WLAN”) as such 802.11, 802.15, 802.16, 802.20 or any other IP wireless LAN, the Internet, or a cellular network. The system 10 may also include a server 22 and at least one access point 24 (“AP”). The access point 24 may correspond to a cell of the system 10. One of ordinary skill in the art will understand that the system 10 may include any number of access points 24 and/or cells and that instead of the access point 24, there may be a conventional computing device which has a wireless transducer.

The system 10 may include a plurality of computing devices having wireless communication capability, such as the wireless device 50. The wireless device 50 may have voice, data and/or video capabilities and may be, for example, a radio or mobile phone, a personal data assistant (“PDA”), or a computer (e.g., including a wireless network PC card or a mobile processor having an integrated wireless LAN solution). The wireless device 50 may also include a conventional barcode scanner. The wireless device 50 may include a wireless transducer (not shown) to wirelessly receive and transmit data. The access point (“AP”) 24 may transmit data to the wireless devices 50 at an AP transmitting power level (e.g., 1 mW-1000 mW) and receive data transmitted from the wireless devices 50.

The wireless device 50 according to the present invention may transmit data and receive data via the access point 24 at a specific transmitting power level. The wireless device 50 may also include a power adjustment arrangement (not shown) to vary the transmitting power level depending on the required transmitting power at a given location or time. For example, the wireless device 50 may require a higher transmitting power level due to obstructions between the wireless device 50 and the access point 24.

The wireless device 50 may increase or decrease the transmitting power as, e.g., a distance between the wireless device 50 and the access point 24 changes. As shown in FIG. 1, for example, the wireless device 50 is first located at a distance X from the access point 24 and then moved to a further location located at a distance Y from the access point 24. The distance Y is greater than the distance X. The transmitting power of the wireless device 50 at the distance Y therefore is greater than the transmitting power of the wireless device 50 at the distance X. Those skilled in the art would understand that there may be factors, other than distance, that may influence the need for adjusting the transmitting power.

The transmitting power of the wireless device 50 according to the present invention may be adjusted manually by a user or automatically. For example, the power adjustment arrangement may automatically adjust the transmitting power as the wireless device 50 changes the locations with reference to the access point 24. As shown in FIG. 1, the wireless device 50 may be moving in a general direction away from the access point 24, e.g., from the distance X to the distance Y. The transmitting may increase as the wireless device 50 moves from the distance X to the distance Y.

The transmitting power of the wireless device 50 may be varied on a continuum or in discrete steps. For example, the wireless device 50 may be transmitting data at a first transmitting power (e.g., low) at the distance X. At a certain distance between the distance X and the distance Y, the wireless device 50 may begin transmitting data at a second transmitting power (e.g., medium). Upon reaching the distance Y, the wireless device 50 may begin transmitting data at a third transmitting power (e.g., higher). In other embodiments, the transmitting power adjusts continuously between the distances X and Y.

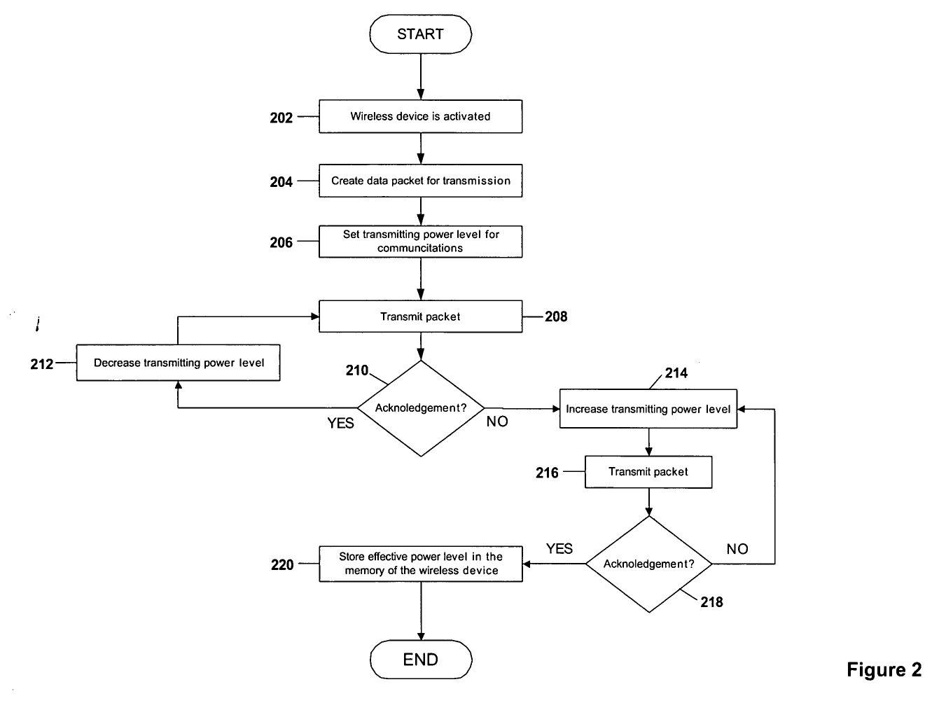

FIG. 2 shows an exemplary method 200 according to the present invention for reducing power in the wireless device 50. In step 202, the wireless device 50 is activated or powered on.

In step 204, the wireless device 50 creates a packet (e.g., a data or information packet) to be transmitted via the access point 24 and/or the communications network 20. In step 206, a first transmitting power level of the wireless device 50, at which the packet will be transmitted, is set. The transmitting power level may be set manually or automatically. For example, the wireless device 50 may automatically set or default the transmitting power level to a lowest power level (e.g., 1 mW or less) upon activation. In other embodiments, the wireless device 50 may default to the highest or last used transmitting power level upon activation.

In step 208, the wireless device 50 transmits the packet. As one of ordinary skill in the art will understand, the wireless device 50 may or may not receive an acknowledgment from, e.g., from the server 22 and/or the AP 24 (step 210). If the acknowledgment is received (i.e., the transmitting power level is effective), the wireless device 50 may decrease the transmitting power level (step 212). As one of ordinary skill in the art will understand, the transmitting power level is decreased to determine a minimum effective transmitting power level. For example, the transmitting power level may be decreased to a second transmitting power level (e.g., decreased mW) and the wireless device 50 may transmit a second packet (step 208). Steps 208-212 may be repeated until no acknowledgment is received by the wireless device 50 (step 210). For example, the acknowledgment will not be received when the transmitting power level of the wireless device 50 is below a minimum effective transmitting power level.

Upon the failure to receive the acknowledgment (step 210), the transmitting power level must then be increased (step 214) and another packet transmitted (step 216) to determine the minimum effective transmitting power level. If an acknowledgment is received (step 218), the minimum effective transmitting power level has been determined. The wireless device 50 may then store the minimum effective transmitting power level in a memory of the wireless device (step 220). If an acknowledgment is not received (step 218), the transmitting power level must again be increased (step 214) and steps 216-218 repeated.

Additional packets (or any other data or information known to those of ordinary skill in the art) may optionally be transmitted after determining the minimum effective transmitting power level. If the acknowledgment is not received during any subsequent transmission, the transmitting power level must be readjusted. For example, the wireless device 50 moves from the distance X to the distance Y while exchanging data via the AP 24. The transmitting power level of the wireless device 50 may be set to a first power level at the distance X. As the wireless device 50 approaches a midpoint between the distances X and Y, the wireless device 50 may fail to receive an acknowledgment from the communications network 20. The transmitting power level may then be raised to a second power level which is higher than the first and the acknowledgment is received. As the wireless device 50 approaches the distance Y, the wireless device 50 may again fail to receive acknowledgment of a transmission. The transmitting power level may then be raised to a higher third power level at which acknowledgment is received.

In the exemplary method shown in FIG. 2 according to the present invention, a packet may be transmitted upon a user's request or at specified time intervals. For example, a wireless device may verify it's power level at specified time intervals (e.g., every 2 seconds) via a packet transmission. A packet may be transmitted (see step 208) in accordance with the predetermined time interval to determine if the transmitting power level may be increased or decreased. For example, the wireless device 50 may move from the distance Y back to the distance X. Beginning at the third power level, the transmitting power level may be decreased (e.g., in discrete steps or continuously) as the wireless device 50 approaches the distance X. For example, the transmitting power level may be decreased each time an acknowledgment is received. When no acknowledgment is received, the transmitting power level may be raised to the last known effective transmitting power level (as described above).

In some embodiments of the present invention, the time interval for power level verification may be adjusted by a user. For example, a wireless device that resides in one location use a long time interval (e.g., several hours). A portable wireless device that is regularly transported (e.g., a PDA or mobile phone) may require a much shorter time interval (e.g., two seconds).

Some of advantages of the present invention include reduced power consumption and prolonged battery life. The present invention may also reduce interference and congestion in wireless networks. For example, continuously limiting the transmitting power level to the minimum effective transmitting power level may ensure that the transmitting range of the wireless device is optimized.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. A system, comprising:
a first computing device including a first wireless transducer; and
a second computing device including a second wireless transducer and a power adjusting arrangement,
wherein the second transducer wirelessly transmits to the first device first data at a first transmitting power and second data at a second transmitting power, the power adjusting arrangement determining the second transmitting power as a function of the first transmitting power and receipt data, the receipt data corresponding to one of (i) an acknowledgment from the first device of reception of the first data and a signal strength of the received first data and (ii) a lack of acknowledgment from the first device of reception of the first data.

2. The system according to claim 1, wherein the first computing device is an access point.

3. The system according to claim 2, wherein the second device communicated with a third computing device, via the access point which is connected to a communications network, the third device being connected to the communications network.

4. The system according to claim 1, wherein the second device includes a barcode scanner.

5. The system according to claim 1, wherein the second device is a mobile device.

6. The system according to claim 1, wherein the power adjusting arrangement determines a third transmitting power as a function of the first transmitting power, the second transmitting power, the receipt data and further receipt data, the further receipt data corresponding to one of (i) an acknowledgment from the first device of reception of the second data and a further signal strength of the received second data and (ii) a lack of acknowledgment from the first device of reception of the second data.

7. The system according to claim 1, wherein the second device is at a first distance from the first device when transmitting the first data at the first transmitting power, the second device being at a second distance from the first device when transmitting the second data at the second transmitting power, the power adjusting arrangement determining the second transmitting power as a function of the first transmitting power, the first distance, the second distance and the receipt data.

8. The system according to claim 1, wherein the second transmitting power is determined every predetermined time period.

9. The system according to claim 1, wherein the first transmitting power is a lowest transmitting power of the second device.

10. The system according to claim 1, wherein the first transmitting power is a transmitting power utilized by the second device during a previous wireless communication.

11. The system according to claim 1, wherein when the receipt data includes the lack of acknowledgment, the power adjusting arrangement sets the second transmitting power to be higher than the first transmitting power and wherein when the receipt data includes the acknowledgment and the signal strength, the power adjusting arrangement sets the second transmitting power to be lower than the first transmitting power.

12. The system according to claim 6, wherein when the receipt data includes the lack of acknowledgment and the further receipt data includes the lack of acknowledgment, the power adjusting arrangement sets the third transmitting power to be higher than the second transmitting power and wherein when the receipt data includes the acknowledgment and the signal strength and the further receipt data includes the acknowledgment and the further signal strength, the power adjusting arrangement sets the third transmitting power to be lower than the second transmitting power.

13. The system according to claim 6, wherein when the receipt data includes the acknowledgment and the signal strength and the further receipt data includes the lack of acknowledgment, the power adjusting arrangement sets the third transmitting power to be equal to the first transmitting power.

14. The system according to claim 6, wherein when the receipt data includes the lack of acknowledgment and the further receipt data includes the acknowledgment and the further signal strength, the power adjusting arrangement sets the third transmitting power to be greater than the first transmitting power and less or equal than the second transmitting power.

15. A method, comprising:
transmitting to a first wireless device by a second wireless device first device first data at a first transmitting power;
receiving from the first device by the second device receipt data, the receipt data corresponding to one of (i) an acknowledgment from the first device of reception of the first data and a signal strength of the received first data and (ii) a lack of acknowledgment from the first device of reception of the first data; and
determining a second transmitting power by the second device as a function of the first transmitting power and the receipt; data.

16. The method according to claim 15, further comprising:
transmitting by the second device to the first device second data at a second transmitting power.

17. The method according to claim 15, wherein the first computing device is an access point.

18. The method according to claim 15, wherein the second device includes a barcode scanner.

19. The method according to claim 16, further comprising:
receiving further receipt data which corresponds to one of (i) an acknowledgment from the first device of reception of the second data and a further signal strength of the received second data and (ii) a lack of acknowledgment from the first device of reception of the second data; and
determining by the second device a third transmitting power as a function of the first transmitting power, the second transmitting power, the receipt data and further receipt data.

20. The method according to claim 15, further comprising:
when the receipt data includes the lack of acknowledgment, increasing the second transmitting power to be higher than the first transmitting power; and
when the receipt data includes the acknowledgment and the signal strength, decreasing the second transmitting power to be lower than the first transmitting power.

21. The method according to claim 19, further comprising:
when the receipt data includes the lack of acknowledgment and the further receipt data includes the lack of acknowledgment, increasing the third transmitting power to be higher than the second transmitting power; and
when the receipt data includes the acknowledgment and the signal strength and the further receipt data includes the acknowledgment and the further signal strength, setting the third transmitting power to be lower than the second transmitting power.

22. The method according to claim 19, further comprising:
when the receipt data includes the acknowledgment and the signal strength and the further receipt data includes the lack of acknowledgment, setting the third transmitting power to be equal to the first transmitting power.

23. The method according to claim 19, further comprising:
when the receipt data includes the lack of acknowledgment and the further receipt data includes the acknowledgment and the further signal strength, setting the third transmitting power to be greater than the first transmitting power and less or equal than the second transmitting power.

24. A device, comprising:
a wireless transducer; and
a power adjusting arrangement,
wherein the transducer wirelessly transmits to a wireless arrangement first data at a first transmitting power and second data at a second transmitting power, the power adjusting arrangement determining the second transmitting power as a function of the first transmitting power and receipt data, the receipt data corresponding to one of (i) an acknowledgment from the wireless arrangement of reception of the first data and a signal strength of the received first data and (ii) a lack of acknowledgment from the first device of reception of the first data.

25. The device according to claim 24, wherein the wireless arrangement is an access point.

26. The device according to claim 24, further comprising:
a barcode scanner.

27. The device according to claim 24, wherein the device is a mobile device.

28. The device according to claim 24, wherein the power adjusting arrangement determines a third transmitting power as a function of the first transmitting power, the second transmitting power, the receipt data and further receipt data, the further receipt data corresponding to one of (i) an acknowledgment from the wireless arrangement of reception of the second data and a further signal strength of the received second data and (ii) a lack of acknowledgment from the wireless arrangement of reception of the second data.
